(19) United States
(12) Patent Application Publication
(10) Pub. No.: US 2018/0229404 A1
(43) Pub. Date: Aug. 16, 2018

(54) Ultraviolet light curing

(71) Applicant: Rush Sales Company, Inc., Odessa, TX (US)

(72) Inventors: James Ray Starr, Gardendale, TX (US); Jim Joseph Poer, Midland, TX (US)

(21) Appl. No.: 15/932,296

(22) Filed: Feb. 16, 2018

Related U.S. Application Data
(60) Provisional application No. 62/459,922, filed on Feb. 16, 2017.

(51) Int. Cl. B29C 35/08; B29C 63/34; B29C 73/10

(52) U.S. Cl. CPC B29C 35/0805; B29C 2035/0827; B29C 73/10; B29C 63/34

(57) ABSTRACT

An ultraviolet light train apparatus for curing of a resin-impregnated liner, having an auto-uprighting camera at one end of the ultraviolet light train apparatus; a multiconductor cable at the opposite end of the ultraviolet light train apparatus; a body comprising one or more ultraviolet LED light bars joining the two ends of the ultraviolet light train apparatus; a coupler connected to the body at a first end of the coupler; and an adjustable wheel connected to the coupler at a second end of the coupler. Alternatively the apparatus and/or methodology may be a UV LED lateral sealing unit having a stability bar/tube, end caps, a camera for lateral viewing, a camera for front facing pan/tilt viewing, high power UV LED(s), a wheel, and inflatable sealing bladders.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### REFERENCE TO A “SEQUENCE LISTING”, A TABLE, OR A COMPUTER PROGRAM

Not Applicable.

### BACKGROUND

### Technical Field

The subject matter generally relates to an apparatus and methods in the field of cured-in-place-pipe installation for reconstruction of pipeline(s) and conduit(s).

Needs exist for the repair and/or rehabilitation of pipeline(s) and conduit(s). One such technique for accomplishing same is referred to as “Cured-in-place” pipe or “CIPP”. “Cured-in-place” pipe has the advantage of being a trenchless technique for repair and/or rehabilitation of pipeline(s) and/or conduit(s) that is either leaking or structurally unsound. Normally Cured-in-place pipe (initially as a liner installed as it is wet out on site or off sight) is installed into the existing pipe/conduit in one of two ways. The first is by pulling a resin-impregnated flexible tube into place (“Pulled-in-Place”) for curing-in-place of, typically, a thermosetting resin pipe. The second is by inverting or inversion of the typically resin-impregnated flexible tube/pipe/conduit under pressure for curing-in-place of the typically resin-impregnated tube). Sometimes the liner can be installed through a manhole or other pre-existing access point. After installation the liner must be cured for a sufficient period of time.

The pulled-in-place method generally includes impregnating a coated lining tube with resin and pulling this lining tube (liner) into the existing pipe. Next, the liner is expanded, generally by inflating a bladder with water or air. Then, the resin is cured by applying heat (such as, for example, by steam, hot water, or metal hydride lamps pulled through the liner). Pulled-in-place liners typically have exterior and interior coatings to hold the resin in the flexible tube during the impregnation process and to prevent the loss of resin during the pulling/insertion step(s). Heating the liners using these conventional methods sometimes resulted in exploded bladders or damage to the liner, bladder, and/or the existing pipe. Thus, an improved method for curing liners is needed.

The inversion method generally includes inverting a resin-impregnated liner tube through the existing pipe. The liner tube is essentially pushed inside-out using water or air pressure. The outside of inverted liners are coated to hold the resin, but during installation the coating is inverted with the liner and serves as a coating on the inside of the liner with the wet resin now on the exterior of the liner. The process and system may vary depending on whether water or air pressure is used to invert the liner. The curing step may be performed by circulating hot water through recirculation hoses in the liner tube or by introducing or circulating controlled steam.

### BRIEF SUMMARY

An ultraviolet light train apparatus for curing of a resin-impregnated liner, having an auto-uprighting camera at one end of the ultraviolet light train apparatus; a multiconductor cable at the opposite end of the ultraviolet light train apparatus; and a body comprising one or more ultraviolet LED light bars joining the two ends of the ultraviolet light train apparatus. Alternatively the apparatus and/or methodology may be a UV LED lateral sealing unit having a stability bar/tube, end caps, a camera for lateral viewing, a camera for front facing pan/tilt viewing, high power UV LED(s), a wheel, and inflatable sealing bladders.

The term “ultraviolet” may also be referred to as “UV”. The terms light emitting diode may also be referred to as “LED”. The term “clear” may refer to a material that at least allows UV light to pass therethrough.

### BRIEF DESCRIPTION OF THE FIGURES

The exemplary embodiments may be better understood, and numerous objects, features, and advantages made apparent to those skilled in the art by referencing the accompanying drawings. These drawings are used to illustrate only exemplary embodiments, and are not to be considered limiting of its scope, for the disclosure may admit to other equally effective exemplary embodiments. The figures are not necessarily to scale and certain features and certain views of the figures may be shown exaggerated in scale or in schematic in the interest of clarity and conciseness.

FIG. 1 depicts a perspective view of an exemplary embodiment of an ultraviolet light train apparatus used for curing of “cured-in-place” pipe.

FIG. 2 depicts a perspective view of an exemplary embodiment of an auto-uprighting camera of the ultraviolet light train apparatus.

FIG. 3 depicts a perspective view of an exemplary embodiment of an ultraviolet LED light bar of the ultraviolet light train apparatus.

FIG. 4 depicts a perspective view of an exemplary embodiment of a connector and multiconductor cable of the ultraviolet light train apparatus.

FIG. 5 depicts a breakaway elevation view of an exemplary embodiment of the ultraviolet light train apparatus within a resin impregnated liner.

FIG. 6 depicts an elevation view of an exemplary embodiment of an UV LED lateral sealing unit, less the bladders.

FIG. 7 depicts a perspective view of an exemplary embodiment of an UV LED lateral sealing unit, less the bladders.

FIG. 8 depicts a side elevational view of an exemplary embodiment of an UV LED lateral sealing unit.

FIG. 9 depicts an end elevational view of an exemplary embodiment of an UV LED lateral sealing unit.

FIG. 10 depicts a perspective view of another exemplary embodiment of an ultraviolet light train apparatus used for curing of “cured-in-place” pipe.

FIG. 11 depicts a perspective view of the FIG. 10 exemplary embodiment of an auto-uprighting camera of the ultraviolet light train apparatus.

FIG. 12 depicts a perspective view of the FIG. 10 exemplary embodiment of an ultraviolet LED light bar of the ultraviolet light train apparatus.

FIG. 13 depicts a perspective view of the FIG. 10 exemplary embodiment of a connector and multiconductor cable of the ultraviolet light train apparatus.

FIG. 14 depicts a breakaway elevation view of the FIG. 10 exemplary embodiment of the ultraviolet light train apparatus within a resin impregnated liner.

### DETAILED DESCRIPTION OF THE EXEMPLARY EMBODIMENT(S)

The description that follows includes exemplary apparatus, methods, techniques, and instruction sequences that embody techniques of the inventive subject matter. However, it is understood that the described exemplary embodiments may be practiced without these specific details.

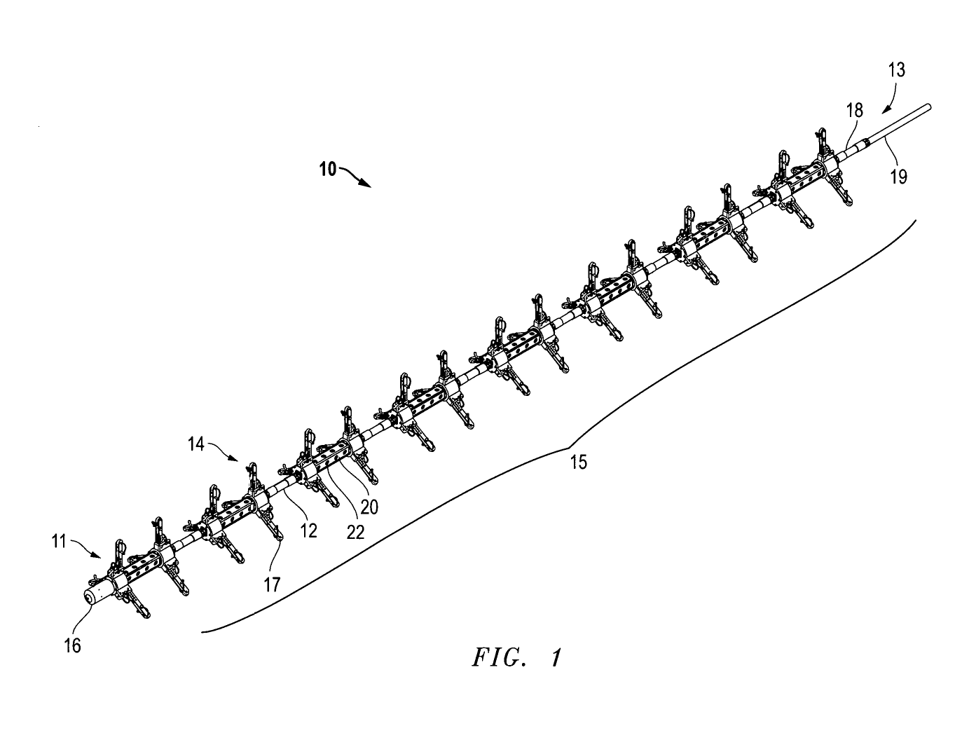

Referring to FIG. 1, a perspective view of an exemplary embodiment of an ultraviolet light train apparatus or system 10 is shown. The UV light train apparatus 10 includes an auto-uprighting or self-leveling camera 16 at a first end 11 and a multiconductor cable 19 at a second end 13. The multiconductor cable 19 is further joined to an electric connector 18. The body 15 of the ultraviolet light train apparatus 10 also includes a number of ultraviolet LED light bars 20 and interconnect hose 12 between the two ends 11, 13. The electric connector 18 is joined to a first ultraviolet LED light bar 20 through a coupler or connector 14. Each subsequent ultraviolet LED light bar 20 may be joined to an interconnect hose 12 by way of another coupler 14. As depicted in FIG. 1, there are seven UV LED light bars 20 in the exemplary embodiment shown, each joined to a interconnect hose 12 via a coupler 14. By way of example only, an alternative exemplary embodiment of a UV light train apparatus 10 may include eight (or more, or less) UV LED light bars 20, and may or may not include as many interconnect hose segments 12. A coupler 14 may also join the auto-uprighting camera 16 to the body 15 of the ultraviolet light train apparatus 10.

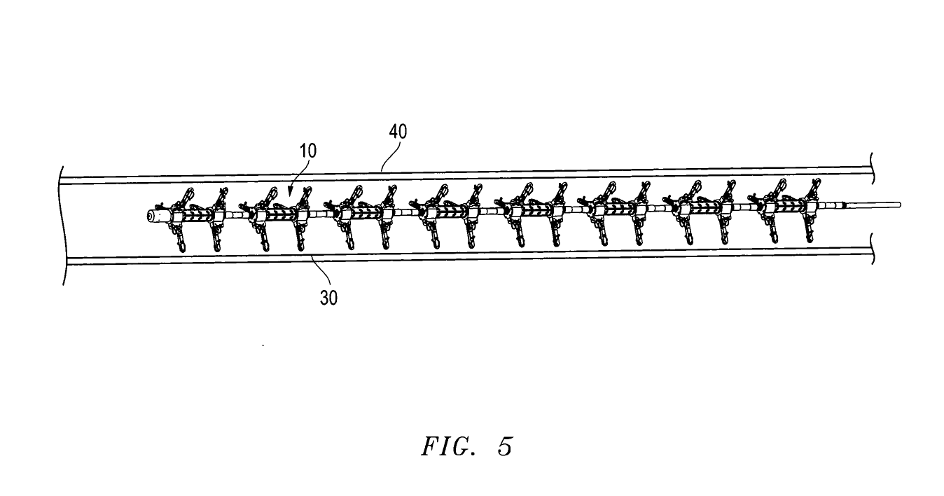

One or more adjustable wheel sets 17 may be installed on each coupler 14. The adjustable wheel sets 17 may be positioned around the circumference of the coupler 14 to enable or allow a range of movement of the UV light train apparatus 10 within the resin impregnated liner 30 (see FIG. 5) without damage to either the liner 30 or the UV light train apparatus 10. The adjustable wheel set 17 may be configured to accommodate pipes 40, by way of example only but not limited to, between about six (or eight) inches to about sixty inches (about 15.24 cm to about 152.4 .cm) in diameter. In the exemplary embodiments as depicted, each coupler 14 has three adjustable wheel sets 17 installed about the perimeter of the coupler 14; however, in alternative exemplary embodiments, a greater or fewer number of adjustable wheel sets 17 may be installed per coupler 14.

In the exemplary embodiment(s) shown, each segment of UV LED light bars 20 is staggered from another consecutive segment by a segment of an interconnect hose 12 (except at second end 13). Other arrangements are possible.

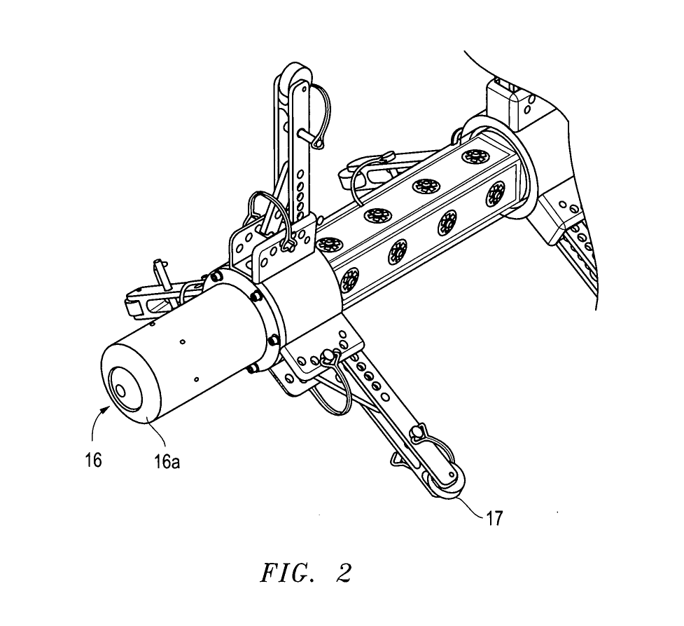

Referring to FIG. 2, a perspective view of an exemplary embodiment of an auto-uprighting camera 16 is shown. The auto-uprighting camera 16 may be a commercially available camera and enables the operator to pre-inspect the liner 30 before “cooking off” or curing of the liner 30. The auto-uprighting camera 16 may be installed on a camera body 16a. Adjustable wheel sets 17 may also be installed about the circumference of the camera body 16a. Multiconductor cables 19 connect the auto-uprighting camera 16 to the body 15 of the UV light train apparatus 10. The multiconductor cables 19 may transmit actuation control, audio, visual and other data transmission and communications between the auto-uprighting camera 16 and the operator of the UV light train apparatus 10. In alternative exemplary embodiments, the auto-uprighting camera 16 may transmit data through air or through wireless communication, or have the capability to utilize both wired and wireless communication.

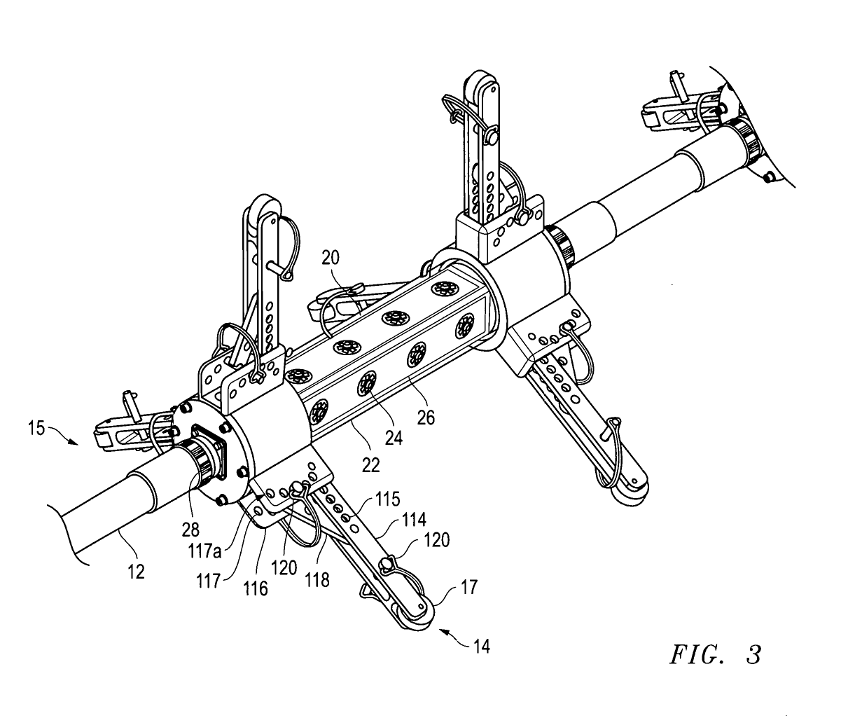

FIG. 3 depicts an exemplary embodiment of an ultraviolet LED light bar 20. The ultraviolet LED light bar 20 includes one or more high power UV LEDs 24 installed on a mount 26 and a clear quartz tube 22 encapsulating the mount 26 and UV LEDs 24. While the mount 26 is shown as a square tube with four UV LEDs 24 installed along each panel of the square tube mount 26 in the figures, it is to be appreciated that any form of the mount 26 is possible (such as, by way of example only, a cylindrical tube), and any number of UV LEDs 24 may be used, along with any placement configuration of the UV LEDs 24 along the mount 26.

The clear outer quartz tube or tubing 22 enables the ultraviolet LED light bar 20 to be sealed and protected from water ingress, and may allow light desired to pass there-through. The clear quartz tubing 22 allows the use of UV LEDs 24 instead of metal hydride or high pressure sodium lighting, and also allows for the more efficient curing of the liner 30, using a lower consumption of power and Increasing the longevity of the UV LEDs 24.

A coupler 14 is attached at either end of the ultraviolet LED light bar 20, each coupler having an adjustable wheel or set of wheels 17. At end of the coupler 14 not engaged with the ultraviolet LED light bar 20, a interconnect fastener or interconnect connector 28 is affixed to the coupler 14 which joins the coupler 14 to the interconnect hose 12. As best seen in FIG. 3, the exemplary embodiment of the coupler 14 shown has a wheel bracket 114, a light train body bracket 116, brace struts 118, and wire lock pins 120. The light train body bracket 116 has a series of holes 117 arranged around an arc 117a for selective placement of one end of the brace strut 118 via a respective wire lock pin 120 for selective shortening or lengthening of the radial distance/position of each respective wheel 17 toward or away from body 15. The wheel bracket 114 also has a series of holes 115 arranged consecutively along its length for selective placement of the other end of the brace strut 118 via a respective wire lock pin 120. The wire lock pins 120 in certain embodiments may be quick release type of wire lock pins 120. Other types of pins, such as for example a cotter pin, or other types of quick release means or mechanisms, may be used. Corrosion resistant metal or plastic is preferred. The quick release wire lock pins 120 may allow for quick removal, adjustment, or interchanging of brace struts 118, wheel brackets 114 and wheels 17. The quick release wire lock pins 120 may also allow the full retraction of the brace struts 118, wheel brackets 114 and the wheels 17. Wheels 17 are not necessarily required at every coupler joint 14 between interconnect hose 12 and UV LED bar 20. The brace strut 118 may also contain holes and/or notches (at the end) for adjustment, and may be pinned for joining at one or both ends.

The interconnect hose 12 is a flexible tubing which allows the passage of the multiconductor cables 19 and thus wired and wireless data communication from one end 13 to the other end 11 of the UV light train apparatus 10, including to and from the ultraviolet LED light bars 20, auto-uprighting camera 16, the adjustable wheel sets 17, as well as any other described part of the UV light train apparatus 10. The flexibility of the interconnect hose 12 (and multiple couplers 14) also allows the UV light train apparatus 10 to be easily maneuvered within the liner 30 and any pipes or pipe systems 40 which are in need of repair or rehabilitation.

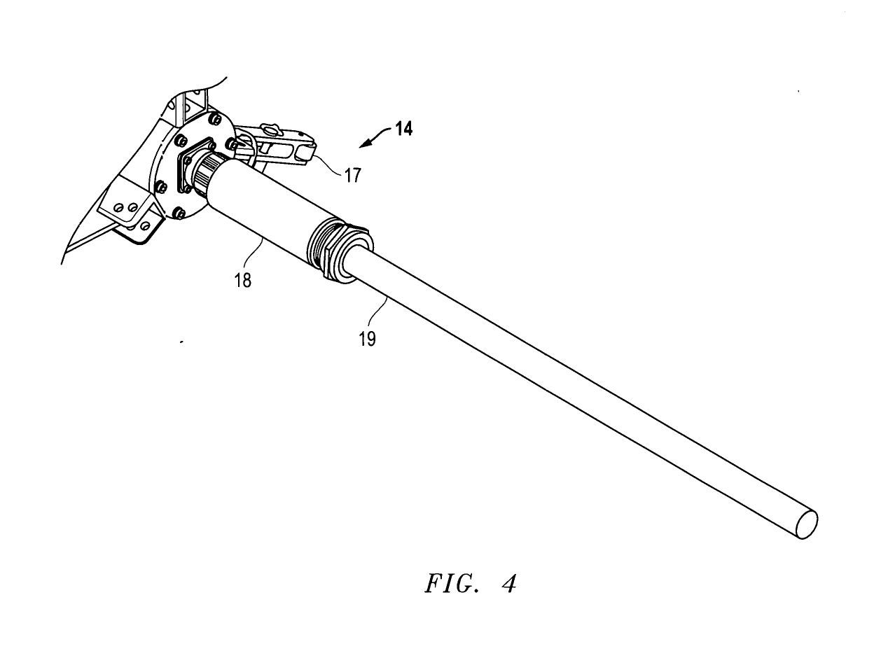

FIG. 4 depicts a perspective view of an exemplary embodiment of the electric connector 18 and multiconductor cable 19 of the UV light train apparatus 10. In the exemplary embodiments depicted, the electric connector 18 may be a twenty pin air over electric connector in data communication with the multiconductor cable 19 which allows for the transmission of audio, visual, control, and other communicable data types. Although the electric connector 18 and multiconductor cable 19 are shown as a wired data communication system, it is to be appreciated that the transmission of data between the UV light train apparatus 10 and the operator may also be wireless.

FIG. 5 depicts a breakaway perspective view of an exemplary embodiment of a UV light train apparatus 10 within a liner 30. The liner 30 may be a resin impregnated fiber glass liner. The liner 30 is pulled into the appropriate location in the pipe system 40 which needs repair or rehabilitation. The use of the auto-uprighting camera 16 may assist in identifying the designated location within the liner 30 to position the UV LED light bars 20 in order cure the resin. A human operator or computer operator may assist in identifying the desired location for the UV light train apparatus 10. The UV light train apparatus 10 may be pulled into place in the liner 30 via conventional methods (by way of example only, methods for pulling in conventional lamps to provide heat for curing resin). Alternatively, the UV light train apparatus 10 may also be motorized into place to the appropriate location. When the UV light train apparatus 10 has been pulled or motorized into place to the designated location (or prior to), the operator may enable or turn on the high power UV LEDs 24 to begin curing the resin impregnated liner 30 by radiating or emitting ultraviolet light beyond the clear quartz tubing 22 to the liner 30. The controls for enabling or disabling the UV LEDs 24, retrieving data from the camera 16, and movement of the UV light train apparatus 10 about the liner 30 and pipe system 40, may be communicated via the multiconductor cable 19 or wirelessly. After a sufficient amount of predetermined time has passed, the operator (or computer system) may switch off or disable the UV LEDs 24, and the auto-uprighting camera 16 may further inspect the cured liner 30.

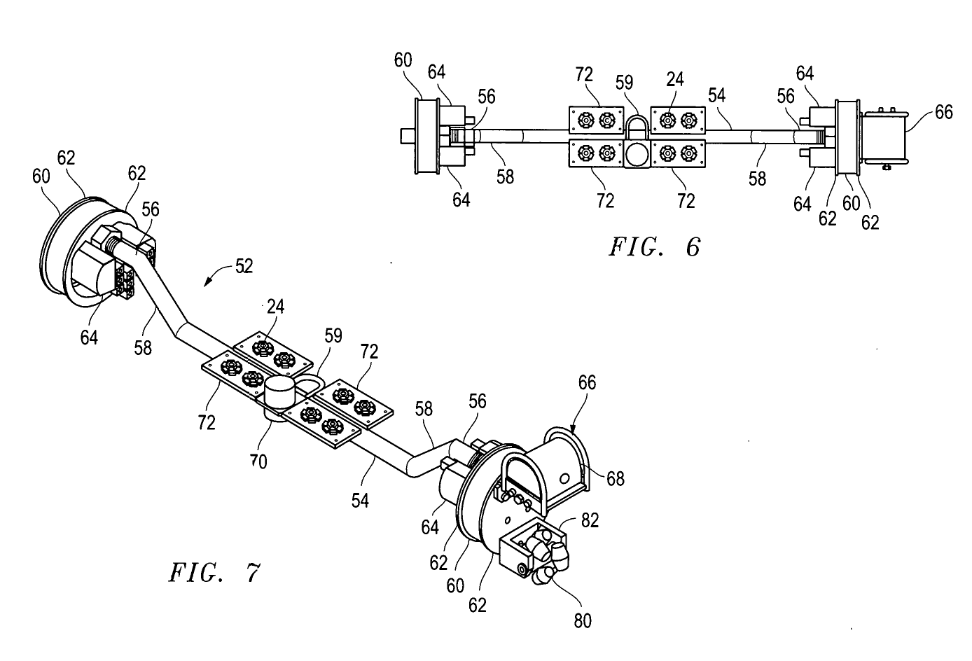

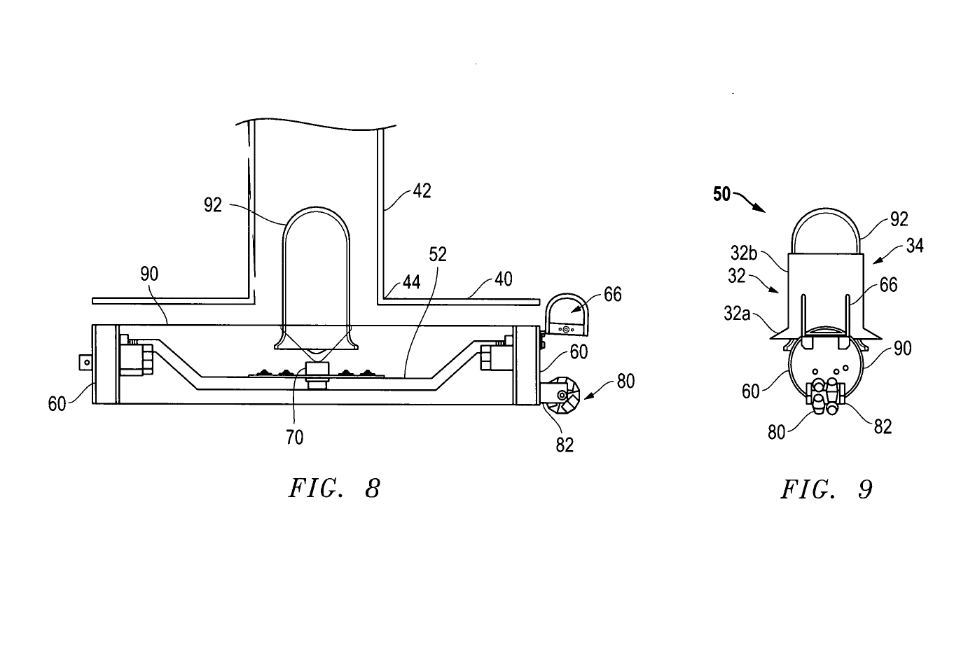

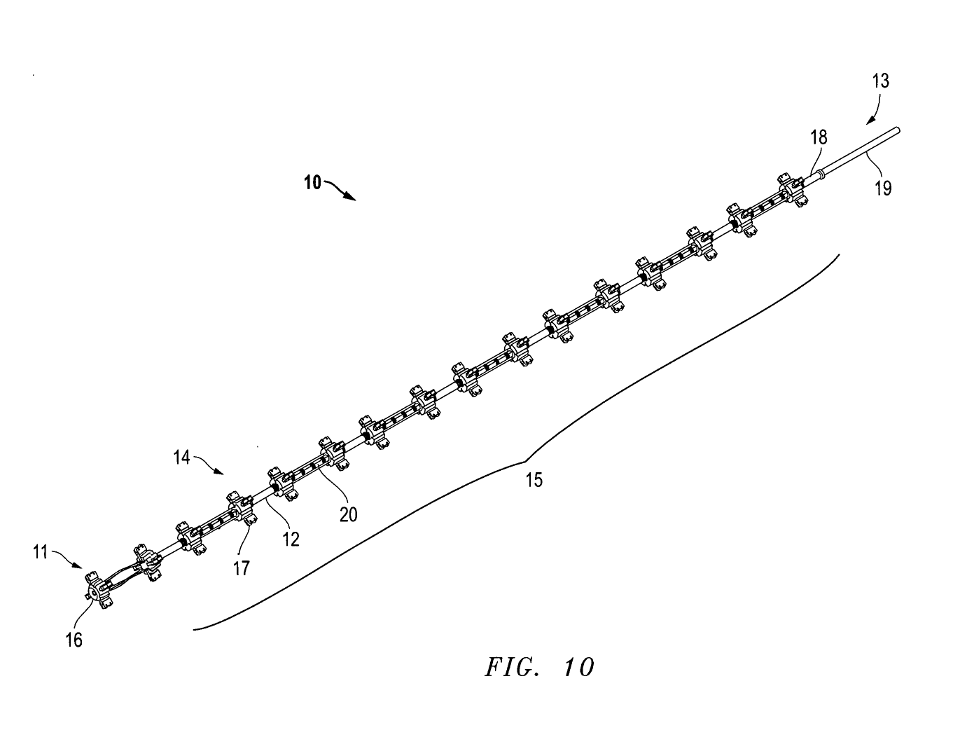

Referring to FIGS. 6-9 an exemplary embodiment of an UV LED lateral sealing unit 50 is shown. The UV LED lateral sealing unit 50 may be used for lateral feel/field and lateral joint or point 44 repair, and for reinstatement of a mainline liner 30 in a mainline pipe 40 to a lateral liner 32 in a lateral pipe 42. The lateral liner 32 (as well as the mainline liner 30) may be impregnated with a resin or epoxy 34 and the liners 32, 30 may generally be pliable until cured as described with the UV LED light train apparatus 10 or UV LED lateral sealing unit 50. The UV LED lateral sealing unit 50 utilizes UV LED light train 10 mode of curing as described above. The UV LED lateral sealing unit 50 generally has a stability bar/tube 52, end caps 60, a camera for lateral viewing 70, a camera 68 for front facing pan/tilt viewing, high power UV LED(s) 24, an omnidirectional wheel 80, a lateral liner 32, and inflatable sealing bladders 90 & 92.

The stability bar/tube 52 has a middle section 54 recessed from opposite end sections 56 by two angled (or sloped) 58 sections relative to both the middle section 54 and the opposite end sections 56. The two angled (or sloped) 58 sections may be at an acute angle, obtuse, forty-five degrees or curved slope. The stability bar 52 is attached to the end caps 60 at the opposite end sections 56. The stability bar 52 has a camera and UV LED mounting feature 59 (such as, for example, a loop).

The end caps 60 have outwardly projecting rims 62 and light/camera connectors 64. The outwardly projecting rims 62 are for connecting and sealing to the main sealing bladder 90. The light/camera connectors 64 are for enabling connection to the camera for lateral viewing 70, and the high power UV LED(s) 24 through the UV LED lateral sealing unit 50 (via end caps 60). At least one end cap may be used for mount of the omnidirectional (preferably), multi-directional, or other wheel 80 (via a mounting bracket 82). A skid (not shown or as modified bracket 82) may be used in place of the wheel 80. A front facing camera mount 66, for mounting of a front facing camera 68 which may be a pan/tilt camera (e.g. rotational in two or three dimensions), may also be attached to at least one end cap 60. The end caps support the stability bar 52 within the main sealing bladder 90.

The camera for lateral viewing 70 may be mounted to the stability bar 52 via the camera and UV LED mounting feature 59 and viewing lateral or at a right angle to the axial direction of the main sealing bladder 90 and/or the stability bar 52. Likewise, the high power UV LED(s) 24 may be mounted to the stability bar 52 via the camera and UV LED mounting feature 59 (including panels 72) and in an orientation lighting laterally or at a right angle relative to the axial direction of the main sealing bladder 90 and/or the stability bar 52. The cameras 16, 70 and 68 may be used to perform pre-inspections of the pipes or lines 40, 42, lateral joints 44, and/or liners 30, 32 before cooking off or curing, as well as post-processing inspections.

The omnidirectional wheel 80 has a mounting bracket 82 for mounting to an end cap 60. The omnidirectional wheel 80 may, for example, be a Mecanum wheel allowing movement in any direction such as within a liner 30 inside pipe 40 (FIG. 5). Although only one omnidirectional wheel 80 is shown more may be implemented as desired.

The liner 30 when used with the UV LED lateral sealing unit 50 may be or include a lateral liner 32 and may rest or sit upon the inflatable sealing bladders 90, 92 until said sealing bladders 90, 92 are inflated at a lateral joint 44 in need of repair. The lateral liner 32 may have an annular ring, brim or base 32a located approximately where the lateral sealing bladder 92 is joined to the main sealing bladder 90 at a right angle. Additionally, the lateral liner 32 may include a cylindrical portion 32b extending upwards or above from the annular ring 32a along the surface of the lateral sealing bladder 92. For installation the lateral liner 32 may be mounted on/over the sealing bladder 92, the cylindrical portion 32b may extend above the top of the lateral sealing bladder 92 (not shown), and the cylindrical portion 32b may also be folded down onto the top of the lateral sealing bladder 92 prior to installation and expansion of the sealing bladder 92.

The inflatable sealing bladders 90 & 92 include the main inflatable sealing bladder 90 and the lateral inflatable sealing bladder 92. The lateral sealing bladder 92 has its long axis oriented at a right angle to the long axis of the main sealing bladder 90. By way of example, the sealing bladders 90 & 92 may be silicone, rubber or other type of expandable/inflatable material encapsulating the mount, high power UV LED(s) 24, and the camera for lateral viewing 70. The sealing bladders 90 & 92 enable the UV LED(s) 24 and camera 70 to be sealed and protected from water ingress, and may allow light desired to pass there-through, and also allows for the more efficient curing of the liners 30 or 32, using a lower consumption of power and increasing the longevity of the UV LEDs 24. After maneuvering the UV lateral sealing unit 50 to the desired lateral joint 44 in need of repair, which can be identified with the front facing camera 68, the operator then inflates or expands the inflatable sealing bladders, 90, 92, such that at least the liner 32 (not shown in FIG. 8 but would normally be present) and optionally 30 are tightly fitted and/or molded against the respective pipes 40 and/or 42 and the lateral joint 44. The UV lateral sealing unit 50 may be maneuvered into place via pulling in or motorizing the UV lateral sealing unit 50 to the appropriate or designated location. The operator may enable or turn on the high power UV LEDs 24 to begin curing the resin impregnated liner 32 by radiating or emitting ultraviolet light beyond the sealing bladders 90 & 92 to at least the liner 32 and optionally liner 30, and/or the operator may enable the camera 70 for viewing. After curing at least the liner 32 and optionally 30, the sealing bladders 90 and 92 can then be deflated and removed from the pipes or lines 40 and 42. Both cameras 70 and 68 may be critical for proper placement of inflatable sealing bladders 90 & 92 for precise placement from pipe 40 of the liner 32 at lateral joint 44 and into later pipe 42, and then subsequent curing of the resin 34 and/or liner 32 via UV LEDs 24 at the later joint 44 and extending into leading portion of lateral pipe 42. Electrical and air/pneumatic lines (not shown) as known to one of ordinary skill in the art can connect to inflatable sealing bladders, 90, 92 such as via end cap 60.

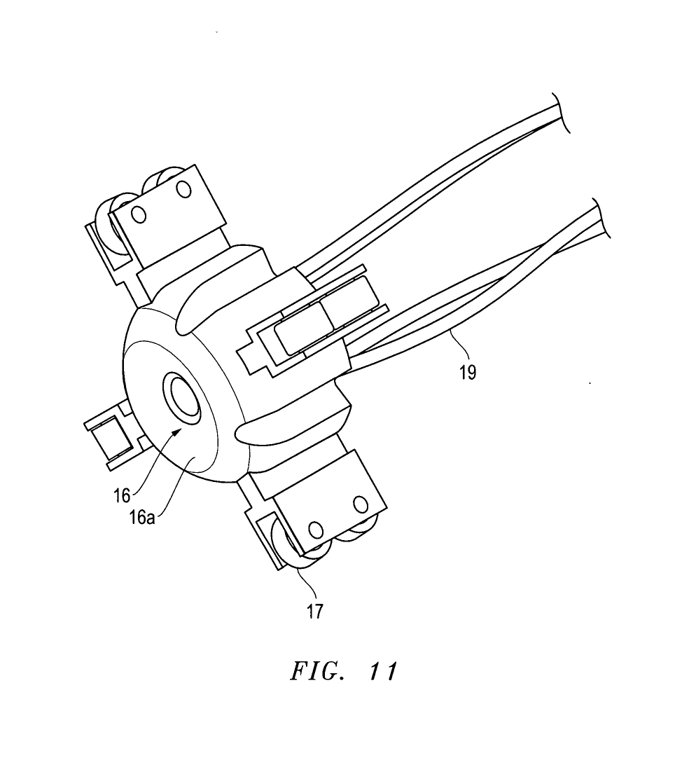

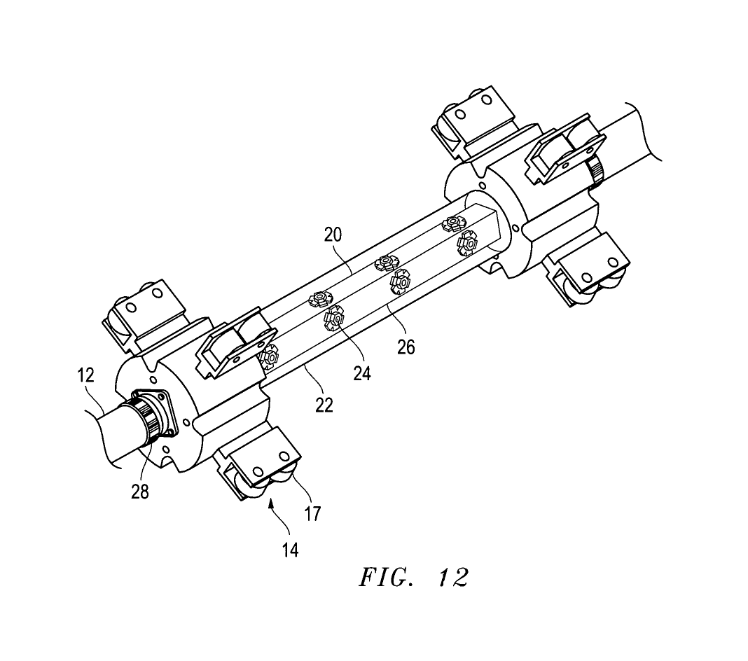

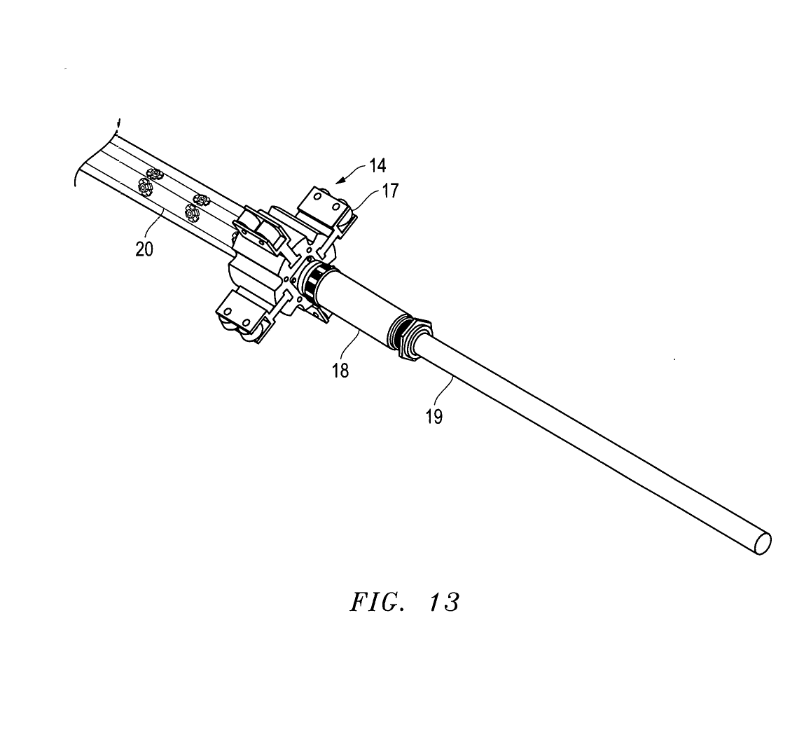

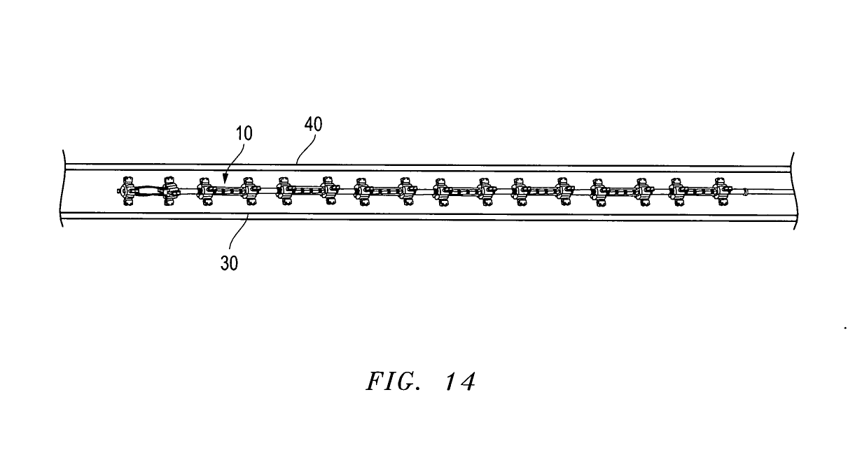

While the exemplary embodiments are described with reference to various implementations and exploitations, it will be understood that these exemplary embodiments are illustrative and that the scope of the inventive subject matter is not limited to them. Many variations, modifications, additions and improvements are possible. By way of example, FIGS. 10-14 represent another exemplary embodiment of the inventive subject matter including the UV light train apparatus 10 having generally a camera 16, UV LED light bars 20, UV LEDs 24, clear quartz tubing 22, couplers 14, wheels 17 within a liner 30 in a pipe system 40. Furthermore, in certain embodiments, positive pressure air can be used within or through the center tube 20 or body 15 to prevent water or other liquids from entering the ultraviolet light train apparatus or system 10. High power UV LEDs 24 in one embodiment are preferably selected from a range of ten to forty Watt UV LEDs.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. An ultraviolet light train apparatus for curing of a resin-impregnated liner, comprising:
an auto-uprighting camera at a first end of the ultraviolet light train apparatus;
a multiconductor cable at a second end of the ultraviolet light train apparatus;
a body comprising one or more ultraviolet LED light bars, wherein the body joins the first and second ends of the ultraviolet light train apparatus;
a coupler connected to the body at a first end of the coupler; and
an adjustable wheel connected to the coupler at a second end of the coupler.

2. The ultraviolet light train apparatus of claim 1, wherein each of the one or more ultraviolet LED light bars comprises:
a mount;
one or more UV LEDs installed on the mount; and
a tubing surrounding the mount and UV LEDs, wherein the tubing is clear.

3. The ultraviolet light train apparatus of claim 2, wherein the coupler comprises
a body bracket at the first end of the coupler; and
a wheel bracket at the second end of the coupler, wherein the adjustable wheel is connected to the coupler via the wheel bracket.

4. The ultraviolet light train apparatus of claim 3, further comprising a brace strut connecting the body bracket to the wheel bracket.

5. The ultraviolet light train apparatus of claim 4, wherein the tubing is comprised of quartz.

6. A method for curing of a resin-impregnated liner, comprising:
pulling the resin-impregnated liner into place within a pipe system, wherein the pipe system is in need of repair;
pulling a ultraviolet LED light bar into the resin-impregnated liner, wherein the ultraviolet LED light bar comprises a clear tubing surrounding the ultraviolet LED light bar;
emitting ultraviolet light beyond the clear tubing to the resin-impregnated liner;
adjusting a radial distance of an adjustable wheel from a body, wherein the body comprises the ultraviolet LED light bar; a body bracket connected to a wheel bracket; and wherein the adjustable wheel is connected to the wheel bracket.

7. The method according to claim 6, wherein the step of adjusting the radial distance of the adjustable wheel from the body comprises selectively placing a pin into a brace strut, wherein the brace strut is located between the body bracket and the wheel bracket.

8. The method according to claim 7, further comprising the steps of installing a camera on the body; and auto-uprighting the camera.

9. The method according to claim 8, further comprising the steps of removing the wheel bracket by removing the pin; adding a second wheel bracket having a different length than the first wheel bracket; and reinserting the pin.

10. A UV LED lateral sealing unit apparatus, comprising:
a stability bar;
two end caps supporting the stability bar;
a camera for lateral viewing mounted to the stability bar;
at least one high power UV LED mounted to the stability bar;
a front facing camera mounted to one of the end caps;
a main sealing bladder mounted on the end caps; and
a lateral sealing bladder connected to the main sealing bladder.

11. The UV LED lateral sealing unit apparatus of claim 10, wherein the at least one high power UV LED is further mounted to a panel, wherein the panel is mounted onto the stability bar.

12. The UV LED lateral sealing unit apparatus of claim 11, further comprising an omnidirectional wheel connected to one of the end caps.

13. The UV LED lateral sealing unit apparatus of claim 12, wherein the main sealing bladder and the lateral sealing bladder comprise an expandable material, and further wherein the main sealing bladder and the lateral sealing bladder encapsulate the stability bar and the at least one high power UV LED.

14. The UV LED lateral sealing unit apparatus of claim 13, wherein a long axis of the lateral sealing bladder is oriented at a right angle to a long axis of the main sealing bladder.

15. The UV LED lateral sealing unit apparatus of claim 14, wherein the camera is oriented at a right angle to the long axis of the main sealing bladder.

16. A method for curing of a resin-impregnated liner, comprising
motorizing the resin-impregnated liner into place within a pipe system, wherein the pipe system is in need of repair;
motorizing a stability bar into the resin-impregnated liner, wherein the stability bar comprises at least one ultraviolet LED mounted on the stability bar;
encapsulating the stability bar with a main sealing bladder and a lateral sealing bladder, wherein a long axis of the lateral sealing bladder is connected at a right angle to a long axis of the main sealing bladder; and
emitting ultraviolet light beyond the main sealing bladder and the lateral sealing bladder to the resin-impregnated liner.

17. The method according to claim 16, further comprising the steps of installing a camera on the stability bar; orienting the camera at a right angle to the long axis of the main sealing bladder; and installing a front facing camera facing in the direction of the long axis of the main sealing bladder.

18. The method according to claim 17, wherein the stability bar further comprises an end cap at each end of the stability bar; and further comprising the step of projecting a rim outwardly from each end cap.

19. The method according to claim 18, further comprising the steps of connecting the rim to the main sealing bladder; sealing the rim to the main sealing bladder; and protecting the camera and the at least one ultraviolet LED from water ingress.

20. The method according to claim 19, further comprising the step of allowing movement in all directions with an omnidirectional wheel, wherein the omnidirectional wheel is mounted to one of the end caps.
